(19) United States
(12) Patent Application Publication
(10) Pub. No.: US 2023/0033363 A1
(43) Pub. Date: Feb. 2, 2023

(54) AQUEOUS SOLUTIONS CONTAINING AMINO CARBOXYLIC ACID CHELATORS

(71) Applicant: Ascend Performance Materials Operations LLC, Houston, TX (US)

(72) Inventors: Zheng CHAI, Houston, TX (US); Jefferson EBERT, Houston, TX (US); Joshua ABELL, Houston, TX (US)

(73) Assignee: Ascend Performance Materials Operations LLC, Houston, TX (US)

(21) Appl. No.: 17/871,181

(22) Filed: Jul. 22, 2022

Related U.S. Application Data
(60) Provisional application No. 63/225,146, filed on Jul. 23, 2021.

(51) Int. Cl. C11D 3/33; C11D 1/24; C11D 3/00; C11D 3/30; C11D 3/28

(52) U.S. Cl. CPC C11D 3/33; C11D 1/24; C11D 3/0073; C11D 3/30; C11D 3/28

(57) ABSTRACT

A cleaning composition having an aqueous solutions containing amino carboxylic acid chelators comprising (a) trans-1,2-diaminocyclohexane-N,N,N′,N′-tetraacetic acid monohydrate or salt thereof or (b) iminodiacetic acid or salt thereof may be used as an alternative for phosphates, NTA, and/or EDTA. The cleaning composition is used in industrial, commercial, or residential settings.

### PRIORITY CLAIM

This application claims priority to U.S. Provisional Application No. 63/225,146, filed Jul. 23, 2021, the entireties of which is incorporated herein by reference.

### TECHNICAL FIELD

The present disclosure relates generally to aqueous solutions containing amino carboxylic acid chelators. In particular, the present disclosure relates to cleaning composition containing an effective amount of the aqueous solutions containing amino carboxylic acid chelators.

### BACKGROUND

Chelators, also known as chelating agents and/or sequestering agents, are organic compounds that form bonds with metal atoms and remove soil. Because chelators typically form two or more separate coordinate bonds to a single, central metal atom, chelators can be described as polydentate ligands. Chelators often include sulfur, nitrogen, and/or oxygen, which act as electron-donating atoms in bonds with the metal atom. In particular, nitrilotriacetic acid (NTA) or ethylenediaminetetraacetic acid (EDTA) or polyphosphates such as sodium tripolyphosphate and their salts are used in detergents because of their ability to solubilize preexisting inorganic salts and/or soils. When calcium, magnesium salts precipitate, the crystals may attach to the surface being cleaned and cause undesirable effects. For example, calcium carbonate precipitation on the surface can negatively impact the aesthetic appearance, result in an unclean appearance. The ability of NTA, EDTA and polyphosphates to remove metal ions facilitates the detergency of the solution by preventing hardness precipitation, assisting in soil removal and/or preventing soil redeposition during the wash process. Chelators are useful in a variety of applications, where their propensity to form chelate complexes with metal atoms is important. In addition, to domestic and/or industrial cleaners and/or detergents, chelators are also used in nutritional supplements, in medical treatments (e.g., chelation therapy to remove toxic metals from the body), as contrast agents (e.g., in MRI scans), in the manufacture of catalysts, in removal of metals during water treatment, and in fertilizers. For example, chelators play an important role in treatment of cadmium or mercury poisoning, because the chelators can be selected to selectively bind to the metals and facilitate excretion.

While effective, phosphates, NTA, EDTA are regulated due to environmental and/or health concerns. There is therefore a need in the art for an alternative, and preferably environment friendly, cleaning composition that can reduce the content of phosphorous-containing compounds such as phosphates, phosphonates, phosphites, and acrylic phosphinate polymers, as well as persistent aminocarboxylates such as NTA and EDTA.

Some alternative chelators include, for example, aminopolyphosphonates, polycarboxylates, diethylenetriaminepentaacetic acid (DTPA), hydroxyethylenediaminetriacetic acid (HEDTA), methylglycine diacetic acid (MGDA), or glutamic acid diacetic acid (GLDA). The chelators have found success in replacing phosphate compounds such as sodium tripolyphosphate (“STPP”). Despite the success, these and other conventional chelators, however, exhibit a number of undesirable properties. Some conventional chelators do not demonstrate adequate activity or stability across a wide pH and/or temperature range. Some conventional chelators exhibit an unacceptably high toxicity. Some conventional chelators do not exhibit adequate solubility in aqueous and/or organic solvents. Some conventional chelators have low biodegradability, are potentially carcinogenic, and present high environmental risk.

US Pub. No. 2012/0260938 describes a method of dissolving and/or inhibiting the deposition of scale on a surface of a system comprises the step of bringing the surface of the system into contact with a composition. The composition can comprise from about 3 to about 15 parts by weight of a chelating component such as MGDA, NTA, HEDTA, GLDA, EDTA, DTPA, and mixtures thereof. This disclosed composition can further comprise from about 3 to about 15 parts by weight of an acidic component, which is different than the chelating component. The composition can further comprise at least about 60 parts by weight of water. Each of the parts by weight ranges above are based on 100 parts by weight of the composition. The composition may further comprise a surfactant component and/or a corrosive inhibitor.

U.S. Pat. No. 9,850,453 describes aqueous solution comprising (A) in the range of from 30 to 60% by weight of a complexing agent, selected from the alkali metal salts of MGDA and GLDA, (B) in the range of from 1 to 25% by weight of at least one salt of a sulfonic acid or of an organic acid, percentages referring to the total respective aqueous solution.

Thus, the need exists for cleaning compositions with chelators that demonstrate both efficiency and cost-effectiveness improvements. The cleaning compositions should have adequate stability and activity across a wide pH and/or temperature range, low toxicity, and suitable biodegradability.

### SUMMARY

In some aspects, the present disclosure relates to a cleaning composition comprising from 0.5 to 50 parts by weight of an aqueous solution containing an active component comprising (a) trans-1,2-diaminocyclohexane-N,N,N′,N′-tetraacetic acid monohydrate or salt thereof or (b) iminodiacetic acid or salt thereof, from 0.01 to 25 parts by weight of a surfactant, from 0.01 to 25 parts by weight of a corrosive inhibitor, and remainder parts by weight of water, wherein the parts by weight is based on 100 parts by weight of the composition. In some embodiments, the aqueous solution may be present in an amount from 5 to 30 parts by weight and may contain from 30 to 70% of the active component. In one embodiment, the active component comprises trans-1,2-diaminocyclohexane-N,N,N′,N′-tetraacetic acid. In another embodiment, the active component comprises disodium iminodiacetate. The pH of the aqueous solution may be from 8 to 13. In one embodiment, the cleaning composition may further comprise an alkanolamine comprising monoethanolamine, diethanolamine, triethanolamine, diethylethanolamine, triisopropanolamine, dimethylethanolamine, or combinations thereof. The cleaning composition may comprise from 0.5 to 15 parts by weight of the alkanolamine. In one embodiment, the cleaning composition may comprise an acidic component comprising a sulfuric acid, sulfonic acid, alkylsulfonic acid, nitric acid, acetic acid, formic acid, citric acid, phosphoric acid or combinations thereof. In one embodiment, the surfactant may comprise an alkyl benzene sulfonate. In one embodiment, the corrosive inhibitor may comprise triazoles, benzotriazoles, bisbenzotriazoles, aminotriazoles, alkylaminotriazoles, or the salts or complexes thereof. One example of a corrosive inhibitor is tolyltriazole which may be an equal mixture of 4- and 5-methylbenzotriazole. In one embodiment, the clean composition may comprises less than 0.5 parts by weight of phosphorous-containing compounds and/or chlorine-containing compounds, and may be substantially free of these compounds. One or more additives including bleaches, enzymes, solvents, salts, soil release polymers, foam inhibitors, fragrances, fillers, biocides, inorganic extenders, formulation auxiliaries, solubility improvers, dyes, peroxide stabilizers, electrolytes, soaps, detergents, oxidizing agents, antimicrobial agents, or combinations thereof may be included in cleaning compositions without inhibiting the performance.

In another aspect, the present disclosure relates to a cleaning composition comprising from 0.5 to 50 parts by weight of an aqueous solution containing an active component comprising trans-1,2-diaminocyclohexane-N,N,N′,N′-tetraacetic acid monohydrate or salt thereof, from 0.01 to 25 parts by weight of a surfactant, from 0.01 to 25 parts by weight of a corrosive inhibitor, and remainder parts by weight of water, wherein the parts by weight is based on 100 parts by weight of the composition. In some embodiments, the aqueous solution may be present in an amount from 5 to 30 parts by weight and may contain from 30 to 70% of the active component. In one embodiment, the active component comprises trans-1,2-diaminocyclohexane-N,N,N′,N′-tetraacetic acid. In another embodiment, the active component comprises disodium iminodiacetate. The pH of the aqueous solution may be from 8 to 13. In one embodiment, the cleaning composition may further comprise an alkanolamine comprising monoethanolamine, diethanolamine, triethanolamine, diethylethanolamine, triisopropanolamine, dimethylethanolamine, or combinations thereof. The cleaning composition may comprise from 0.5 to 15 parts by weight of the alkanolamine. In one embodiment, the cleaning composition may comprise an acidic component comprising a sulfuric acid, sulfonic acid, alkylsulfonic acid, nitric acid, acetic acid, formic acid, citric acid, phosphoric acid or combinations thereof. In one embodiment, the surfactant may comprise an alkyl benzene sulfonate. In one embodiment, the corrosive inhibitor may comprise triazoles, benzotriazoles, bisbenzotriazoles, aminotriazoles, alkylaminotriazoles, or the salts or complexes thereof. In one embodiment, the clean composition may comprises less than 0.5 parts by weight of phosphorous-containing compounds and/or chlorine-containing compounds, and may be substantially free of these compounds. One or more additives including bleaches, enzymes, solvents, salts, soil release polymers, foam inhibitors, fragrances, fillers, biocides, inorganic extenders, formulation auxiliaries, solubility improvers, dyes, peroxide stabilizers, electrolytes, soaps, detergents, oxidizing agents, antimicrobial agents, or combinations thereof may be included in cleaning compositions without inhibiting the performance.

In yet another aspect, the present disclosure relates to a cleaning composition comprising from 0.5 to 50 parts by weight of an aqueous solution containing an active component comprising iminodiacetic acid or salt thereof, from 0.01 to 25 parts by weight of a surfactant, from 0.01 to 25 parts by weight of a corrosive inhibitor, and remainder parts by weight of water, wherein the parts by weight is based on 100 parts by weight of the composition. In some embodiments, the aqueous solution may be present in an amount from 5 to 30 parts by weight and may contain from 30 to 70% of the active component. The pH of the aqueous solution may be from 8 to 13. In one embodiment, the cleaning composition may further comprise an alkanolamine comprising monoethanolamine, diethanolamine, triethanolamine, diethylethanolamine, triisopropanolamine, dimethylethanolamine, or combinations thereof. The cleaning composition may comprise from 0.5 to 15 parts by weight of the alkanolamine. In one embodiment, the cleaning composition may comprise an acidic component comprising a sulfuric acid, sulfonic acid, alkylsulfonic acid, nitric acid, acetic acid, formic acid, citric acid, phosphoric acid or combinations thereof. In one embodiment, the surfactant may comprise an alkyl benzene sulfonate. In one embodiment, the corrosive inhibitor may comprise triazoles, benzotriazoles, bisbenzotriazoles, aminotriazoles, alkylaminotriazoles, or the salts or complexes thereof. In one embodiment, the clean composition may comprises less than 0.5 parts by weight of phosphorous-containing compounds and/or chlorine-containing compounds, and may be substantially free of these compounds. One or more additives including bleaches, enzymes, solvents, salts, soil release polymers, foam inhibitors, fragrances, fillers, biocides, inorganic extenders, formulation auxiliaries, solubility improvers, dyes, peroxide stabilizers, electrolytes, soaps, detergents, oxidizing agents, antimicrobial agents, or combinations thereof may be included in cleaning compositions without inhibiting the performance.

### DETAILED DESCRIPTION

One embodiment of the present invention provides a cleaning composition comprising an aqueous solution of an amino carboxylic acid chelator as an active component. The amino carboxylic acid chelator may include trans-1,2-diaminocyclohexane-N,N,N′,N′-tetraacetic acid monohydrate, iminodiacetic acid, or salts thereof. In addition, the cleaning compositions are low-phosphate composition that contain less than 0.5 parts by weight of phosphorous-containing compounds and/or chlorine-containing compounds or may be free of phosphates. In some embodiments, the cleaning compositions may also contain low amounts of ethylenediaminetetraacetic acid (EDTA) and/or nitrilotriacetic acid (NTA), and preferably the cleaning compositions described herein are free of EDTA and/or NTA.

The cleaning compositions described herein have been found to be effective alternatives to EDTA and/or NTA, as well as to other conventional chelators. The active component has been found to provide improved cleaning properties. This allows the cleaning compositions to be easy to handle and use, while also being environmental acceptable. The cleaning compositions may provide sufficient cleaning without building up deposits on the cleaned surfaces. The cleaning compositions may be stable, and is effective in acidic and basic environments over a wide temperature range, up to 150° C., e.g., up to 125° C. or up to 100° C.

In one embodiment, the aqueous solution may comprise from 30 to 70% of the active component, e.g., from 30 to 60%, or from 35 to 55% or more preferably from 40% to 55%. When the active component is present in lower amounts the activity is reduced. The active component may be dissolved in water.

In one embodiment active component is trans-1,2-diaminocyclohexane-N,N,N′,N′-tetraacetic acid or a salt thereof. The trans-1,2-diaminocyclohexane-N,N,N′,N′-tetraacetic acid may be fully neutralized with an alkali metal (lithium, sodium, potassium), or partially neutralized with an average from 3.5 to 4, e.g., from 3.7 to 4, of the acid groups being neutralized with an alkali metal. Thus, in one preferred embodiment the active component is trans-1,2-diaminocyclohexane-N,N,N′,N′-tetraacetic acid, tetrasodium salt (DCTA). DCTA, as well as precursors such as trans-1,2-diaminocyclohexane, are commercially available from Sigma Aldrich, Fisher Scientific, or Tokyo Chemical Industry Co. Ltd. In one embodiment, the aqueous solution may comprise from 30 to 70% of DCTA, e.g., from 30 to 60%, or from 35 to 55% or more preferably from 40% to 55%. In one non-limiting embodiment, trans-1,2-diaminocyclohexane-N,N,N′,N′-tetraacetic acid tetrasodium salt may be the only active component in the aqueous solution.

Although DCTA is a complex agent for sequestering metal ions, DCTA has not been used in cleaning compositions.

In one embodiment active component does not contain detectable amounts of the cis form of diaminocyclohexane-N,N,N′,N′-tetraacetic acid, and comprises more than 99% of the trans form, e.g., more than 99.5% of the trans form, more than 99.9% of the trans form, or more than 99.99% of the trans form.

In one embodiment active component is an iminodiacetic acid or preferably a salt thereof. The iminodiacetic acid may be neutralized with alkali metals or alkaline earth metals, such as lithium, sodium, potassium, magnesium, or calcium. Although the iminodiacetic anion is a tridentate ligand, the acids groups are preferably neutralized with an average from 1.7 to 2.2, e.g., from 1.8 to 2.1, of alkali metals. Suitable salts include disodium iminodiacetate (DSIDA), dilithium iminodiacetate (Li₂IDA), dipotassium iminodiacetate, calcium iminodiacetate, or magnesium iminodiacetate. Trisodium iminodiacetate is not suitable as an active component for cleaning formulation disclosed herein. Thus, in one preferred embodiment the active component is DSIDA. In one embodiment, the aqueous solution may comprise from 30 to 70% of DSIDA, e.g., from 30 to 60%, from 35 to 55%, from 40% to 55% or more preferably from 40% to 45%. In one non-limiting embodiment, DSIDA may be the only active component in the aqueous solution.

Although DSIDA is a complex agent for sequestering metal ions, DSIDA has not been used in cleaning compositions.

The DSIDA suitable for use as an active component preferably contains low amount of impurities, such as iminodiacetic acid. Precipitation of iminodiacetic acid may result in undesired fouling or when present in high amounts may interfere with formulation. In one embodiment, the amount of free iminodiacetic acid in DSIDA is less than 1% by weight, e.g., less than 0.1% by weight or less than 0.01% by weight. Preferably the amount of iminodiacetic acid is kept below detectable levels so that the aqueous composition is substantially free of iminodiacetic acid.

In some embodiments, the active component may comprise a mixture of DCTA and DSIDA. A mixture of active component may comprise from 10 to 90% of DCTA and from 90 to 10% of DSIDA, e.g., from 25 to 75% of DCTA and from 75 to 25% of DSIDA or from 40 to 60% of DCTA and from 60 to 40% of DSIDA.

In one embodiment, the aqueous solution containing the active component has a pH value in the range of from 8 to 14, e.g., from 9 to 13.5 and more preferably from 9.5 to 11. The pH value is determined at ambient temperature.

The active component is in an aqueous solution, such that the active component, e.g., chelator, also includes water, and more preferably demineralized water. In one embodiment, the aqueous solution containing the active component has a total solids content from 25 to 70% by weight, e.g., from 30 to 65% by weight, from 35 to 60% by weight or from 40 to 60% by weight.

Due in part to the improved binding efficiency lower amount of the active component may be used, which advantageous reduces the material needed to achieve the desired cleaning. In one embodiment, the cleaning composition comprises from 0.5 to 50 parts by weight, preferably from 1 to 40 parts by weight, from 5 to 40 parts by weight, from 10 to 40 parts by weight or from 10 to 30 parts by weight, of the aqueous solution containing the active component described herein.

The formulation for the cleaning composition described herein may comprise from 0.01 to 25 parts by weight, preferably from 1 to 25 parts by weight, from 1 to 20 parts by weight or from 1 to 15 parts by weight, of a surfactant, such as an amphoteric surfactant, nonionic surfactant, anionic surfactant, and/or cationic surfactant. In one embodiment, the surfactant may preferably be an anionic surfactant. Examples of suitable water soluble anionic surfactants include, but are not limited to, alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alphaolefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-n-alkyltaurates, or alkyl carboxylates. Alkyl sulfates or alkyl benzene sulfonates are preferred.

In one embodiment the alkyl sulfate is a sodium, potassium, ammonium, ethanolamine, or magnesium salt, preferably with a carbon chain length from 6 units to 20 units. In a preferred embodiment the alkyl sulfate is sodium dodecyl sulfate (sodium lauryl sulfate) or sodium decyl sulfate.

In one embodiment the alkyl benzene sulfonate is linear or branched and is a sodium, potassium, ammonium, or magnesium salt, with a carbon chain length (attached to benzene ring) from 6 units to 20 units. In a preferred embodiment alkyl benzene sulfonate is sodium dodecyl benzene sulfonate or sodium xylene sulfonate.

The anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines. Non-limiting examples of linear alkanolamines include monoethanolamine (MEA), diethanolamine (DEA), triethanolamine (TEA), diethylethanolamine, triisopropanolamine, dimethylethanolamine or combinations thereof. Examples of branched alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

In one embodiment, the cleaning composition may comprise an anionic surfactant as described above, preferably alkyl sulfates or alkyl benzene sulfonates, and an alkanolamine. The formulation for the cleaning composition described herein may comprise from 0.5 to 15 parts by weight of an alkanolamine, preferably from 0.5 to 10 parts by weight, from 0.75 to 7.5 parts by weight, from 1 to 5 parts by weight, or from 2 to 5 parts by weight. In general the amount of alkanolamine is controlled to be less than the active component.

Accordingly, in one embodiment, there is provided a cleaning composition comprising from 0.5 to 50 parts by weight of an aqueous solution containing an active component comprising (a) trans-1,2-diaminocyclohexane-N,N,N′,N′-tetraacetic acid monohydrate or salt thereof or (b) iminodiacetic acid or salt thereof; from 0.5 to 15 parts by weight of an alkanolamine; from 0.01 to 25 parts by weight of a surfactant; from 0.01 to 25 parts by weight of a corrosive inhibitor; and remainder parts by weight of water, wherein the parts by weight is based on 100 parts by weight of the composition

Examples of nonionic surfactants include alcohol ethoxylates such as C₈ to C₁₈ alcohol ethoxylates containing from about 3 to 50 moles of ethylene oxide per molecule; C₈ to C₁₈ fatty acid esters and amides containing from about 2 to 50 moles of ethylene oxide; C₈ to C₁₈ fatty alcohols; C₈ to C₁₈ diols such as tetramethyl decynediol and dimethyl octynediol; block copolymers of polyethylene oxide and polypropylene oxide; C₈ to C₁₈ fatty acid esters of glycerine; ethoxylated and propoxylated C₈ to C₁₈ fatty alcohols; C₈ to C₁₈ fatty amine and amidoamine oxides; C₈ to C₁₈ fatty amides and alkanolamides; and alkyl saccharides (e.g., alkyl glucosides) or alkenyl-saccharides such as a saccharide having the formula: R₁₀—O—(R₁₂O)ₜ-(G)ₚ where R₁₀ is a linear or branched alkyl, alkenyl or alkyl-phenyl group having 6-18 carbon atoms, R₁₂ is an alkylene group having 2-4 carbon atoms, G is a reduced saccharide residue having 5-6 carbon atoms, t is 0-10, and p is 1-10. In one embodiment, the alcohol ethoxylate nonionic surfactants for use in the cleaning compositions are biodegradable.

Corrosive inhibitors may be included in the cleaning composition according to the embodiments disclosed herein in an amount sufficient to provide desired corrosion inhibition properties. The formulation for the cleaning composition described herein may comprise from 0.01 to 25 parts by weight of a corrosive inhibitor, preferably from 1 to 25 parts by weight, from 1 to 20 parts by weight, from 1 to 15 parts by weight, from 1 to 10 parts by weight, or from 1 to 5 parts by weight. Although low amounts of corrosive inhibitor may provide desired corrosion inhibition properties in some formulations, larger amounts of corrosive inhibitor can be employed without deleterious effects.

Examples of suitable corrosive inhibitors include, but are not limited to: a combination of a source of aluminum ion and a source of zinc ion, as well as an alkaline metal silicate or hydrate thereof. Suitable corrosive inhibitors used may be anticorrosives including triazoles, benzotriazoles, bisbenzotriazoles, aminotriazoles, alkylaminotriazoles, or the salts or complexes thereof. The salts may be alkali metal salts, e.g., sodium, or transition metal salts, e.g., silver. In particular, benzotriazoles for use as a metal corrosive inhibitor include, but are not limited to, benzotriazole (BTA), 4-methylbenzotriazole, 5-methylbenzotriazole, 6-methylbenzotriazole, 7-methylbenzotriazole, 5-aminotriazole, 1-hydroxybenzotriazole, 5-phenylthiol-benzotriazole, 5-chlorobenzotriazole, 4-chlorobenzotriazole, 5-bromobenzotriazole, 4-bromobenzotriazole, 5-fluorobenzotriazole, 4-fluorobenzotriazole, naphthotriazole, tolyltriazole, 5-phenyl-benzotriazole, 5-nitrobenzotriazole, 4-nitrobenzotriazole, -amino-5-mercapto-1,2,4-triazole, 2-(5-amino-pentyl)-benzotriazole, 1-amino-benzotriazole, 5-methyl-1H-benzotriazole (or 5-methylbenzotriazole), benzotriazole-5-carboxylic acid, 4-methylbenzotriazole, 4-ethylbenzotriazole, 5-ethylbenzotriazole, 4-propylbenzotriazole, 5-propylbenzotriazole, 4-isopropylbenzotriazole, 5-isopropylbenzotriazole, 4-n-butylbenzotriazole, 5-n-butylbenzotriazole, 4-isobutylbenzotriazole, 5-isobutylbenzotriazole, 4-pentylbenzotriazole, 5-pentylbenzotriazole, 4-hexylbenzotriazole, 5-hexylbenzotriazole, 5-methoxybenzotriazole, 5-hydroxybenzotriazole, dihydroxypropylbenzotriazole, 1-[N,N-bis(2-ethylhexyl)aminomethyl]-benzotriazole, 5-t-butyl benzotriazole, 5-(1′,1′-dimethylpropyl)-benzotriazole, 5-(1′,1′,3′-trimethylbutyl)benzotriazole, 5-n-octyl benzotriazole, and 5-(1′,1′,3′,3′-tetramethylbutyl)benzotriazole, or the alkali metal/transition metal salts or complexes thereof. In a more preferred embodiment, the corrosive inhibitor includes sodium tolyltriazole, which comprises a mixture of 4-methylbenzotriazole and 5-methylbenzotriazole.

Accordingly in one embodiment, there is provided cleaning composition comprising from 0.5 to 50 parts by weight of an aqueous solution containing an active component comprising (a) trans-1,2-diaminocyclohexane-N,N,N′,N′-tetraacetic acid monohydrate or salt thereof or (b) iminodiacetic acid or salt thereof; from 0.01 to 25 parts by weight of a surfactant; from 0.01 to 25 parts by weight of a benzotriazole, preferably a alkali metal/transition metal salts of tolyltriazole; and remainder parts by weight of water, wherein the parts by weight is based on 100 parts by weight of the composition.

The composition further comprises an acidic component. The acidic component may be useful for solubilizing hydrophobic compounds. Typically, the acidic component may be an organic acid, an inorganic acid, or a combination thereof. Examples of suitable acidic components include sulfuric acid, sulfonic acid, alkylsulfonic acid, nitric acid, acetic acid, formic acid, citric acid, phosphoric acid or combinations thereof. The acidic component may alkylated. Other acidic components can include straight chain or branched carboxylic acids including, but not limited to, lactic acid, acetic acid, formic acid, ascorbic acid, oxalic acid, hydroxymaleic acid, methanesulphonic acid, mandelic acid, glycolic acid, salicylic acid, a pyranosidyl acid such as glucuronic acid or galacturonic acid, citric acid, tartaric acid, pamoic acid, alginic acid, gentisic acid, lactobionic acid, succinic acid, polymers of maleic acid and acrylic acid, and copolymers thereof. Other polyamino carboxylic acids in addition to the active agent are not preferred acidic components. Other examples of inorganic acids include, but are not limited to, sulphurous acid, sulfuric acid, hydrochloric acid, hypochlorous acid, chlorous acid, nitric acid, phosphoric acid, amidosulfonic/sulfamic acid, and phosphorous acid. In one embodiment, the acidic component is dodecyl benzene sulfonic acid.

The acidic component may be in amounts from 0 to 15 parts by weight, e.g., from 0.01 to 15 parts by weight, from 0.1 to 15 parts by weight, from 1 to 15 parts by weight, from 3 to 12 parts by weight, from 5 to 10 parts by weight, based on the total weight of the cleaning composition. In some embodiments, the acidic component may be aqueous and the acid is present in amounts from 30 to 95 parts by weight, e.g., from 35 to 90 parts by weight, from 40 to 85 parts by weight, from 45 to 85 parts by weight, or from 50 to 70 parts by weight, based on the weight of the acidic component. In the embodiments where the acidic component is aqueous, the amounts may be adjusted as needed to compensate for dilution.

In one embodiment, the cleaning composition comprises a low amount of phosphorous-containing compounds and/or chlorine-containing compounds. This allows the cleaning composition to be used in formulations that are free of phosphates or chlorine.

In some embodiments, the cleaning compositions of the present disclosure may include a caustic agent to adjust the pH of the composition or alkalinize with the composition. Caustic agents include, but are not limited, to alkali metal and/or alkaline earth bases (such as hydroxides, perborates, carbonates, percarbonates). In particular, the caustic agents may be sodium hydroxide, sodium bicarbonate, potassium hydroxide, potassium carbonate, magnesium hydroxide, magnesium carbonate, calcium hydroxide, calcium carbonate, or combinations thereof. A mixture of caustic agents may be used. In some embodiments, the caustic agent may be used in amounts from 0 to 20 parts by weight, e.g., from 0.01 to 20 parts by weight, from 0.1 to 15 parts by weight, from 0.5 to 10 parts by weight, or from 0.5 to 5 parts by weight, based on the weight of the acidic component. In high caustic compositions, the caustic agents may be in a larger amount, such as more than 40 parts by weight, e.g., more than 45 parts by weight or more than 50 parts by weight.

The cleaning composition described herein contain water as the balance, which may be added from the various components, in particular the aqueous solution, but also may be from the surfactant, or corrosive inhibitor. The total amount of water in the cleaning composition may be more than 40 parts by weight, e.g., more than 45 parts by weight, more than 50 parts by weight, more than 55 parts by weight, more than 60 parts by weight, more than 65 parts by weight, more than 70 parts by weight, more than 75 parts by weight, more than 85 parts by weight, or more than 90 parts by weight. In terms of a range the total amount of water may be from 40 to 95 parts by weight, e.g., from 40 to 90 parts by weight, from 50 to 90 parts by weight, from 60 to 85 parts by weight, or from 65 to 85 parts by weight.

The cleaning composition may include a solvent that includes but is not limited to alcohols, glycols, ethers and glycol ethers. In one embodiment, the cleaning composition comprises from 0 to 40 parts by weight, e.g., from 0.01 to 40 parts by weight, from 0.1 to 35 parts by weight, from 0.5 to 30 parts by weight, from 1 to 30 parts by weight, from 1 to 25 parts by weight. The cleaning compositions may include ethanol, isopropanol, sorbitol, glycerol, 1,3-propanediol, and mixtures thereof. Glycol ethers can include propylene glycol, diethylene glycol monobutyl ether, dipropropylene glycol n-butyl ether, propylene glycol n-butyl ether, ethylene glycol butyl ether, dipropylene glycol monomethylether, propylene glycol, carbitol, methoxypropanol, glycerine, and mixture thereof.

Other additives that do not adversely affect the active component in the formulation may be used. In some embodiments, the formulation may also comprise one or more additives including bleaches, enzymes, solvents, salts, soil release polymers, foam inhibitors, fragrances, fillers, biocides, inorganic extenders, formulation auxiliaries, solubility improvers, dyes, peroxide stabilizers, electrolytes, soaps, detergents, oxidizing agents, antimicrobial agents, or combinations thereof. In some embodiments, the cleaning compositions of the present disclosure may specifically exclude one or more of the additive components; and in the case of more than one of the additive components, the composition may exclude any combination thereof. In one embodiment, the total amount of other additives may be from 0 to 15 parts by weight, e.g., from 0.01 to 15 parts by weight, from 0.1 to 15 parts by weight, from 0.5 to 10 parts by weight, or from 1 to 10 parts by weight.

Examples of suitable foam inhibitors include polysiloxane defoamers (e.g., polydimethylsiloxane), polyethylene glycol methyl ether polymers, ethylene oxide/propylene oxide copolymers, and glycidyl ether capped acetylenic diol ethoxylates.

To illustrate the cleaning compositions described here each of the components is specified in the following formulations, where each component is based on the 100% of the active component, unless noted. Formulation one is a cleaning composition that comprises from 0.5 to 50 parts by weight of an aqueous solution comprising from 30 to 70% of an amino carboxylic acid chelator comprising a salt of trans-1,2-diaminocyclohexane-N,N,N′,N′-tetraacetic acid, from 0.01 to 25 parts by weight of a surfactant comprising a sulfonate, from 0.01 to 25 parts by weight of a corrosive inhibitor comprising a benzotriazole, from 0 to 15 parts by weight of an acidic component comprising an alkylsulfonic acid, and the balance being water. Formulation two is a cleaning composition that comprises from 0.5 to 50 parts by weight of an aqueous solution comprising from 30 to 70% of an amino carboxylic acid chelator comprising disodium iminodiacetate, from 0.01 to 25 parts by weight of a surfactant comprising a sulfonate, from 0.01 to 25 parts by weight of a corrosive inhibitor comprising a benzotriazole, from 0 to 15 parts by weight of an acidic component comprising an alkylsulfonic acid, and the balance being water.

The cleaning composition may be used in an industrial, commercial, or residential setting, including health care and food processing settings. The cleaning compositions provide effective cleaning on a variety of surfaces, including floor, tile, countertop, wall, panel, window, plumbing fixture, kitchen and bathroom furniture, appliance, engine, vehicle, circuit board, and dish. The surface material may be ceramic, porcelain, glass, tile, fiberglass composites, metallic surfaces, laminate surfaces, or hard polymeric surfaces. The cleaning composition may be brought into contact by various methods, including applying to the cleaning composition to the surface by scrubbing, spraying, rolling, dipping or applied by a known technique. The cleaning composition may be used without pretreating the surface.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims or the equivalents thereof.

### EXAMPLES

The following examples illustrate the invention by grease cleanability testing. White ceramic tiles were used as the substrate. Prior to applying the grease blend, the L spectral component (white/black color) of the white ceramic tile was measurement using the Datacolor 600. The grease blend contained of equal parts LubriMatic Moly EP Grease, LPS ThermaPlex CS Moly Bearing Grease, Lubriplate No. 1242 Heavy Duty Lithium Polymer Grease, Liquid Wrench Trailer Bearing Grease, and Loctite LB 8219 Extreme Pressure Grease. The grease blend was applied with a thin measured layer (#40 wire draw down bar—4.0 mil—101.6 microns) to coat the tiles.

After the grease composition was applied, testing was conducted by applying the 100 mL of the cleaning composition using cellulosic sponges. A new sponge was used for every test and 5 cycles were run for each cleaning composition. The cleaning composition were tested on the BYK Scrub Test Apparatus using the greased tile. The panels were drained but not rinsed, wiped, or treated in any manner after scrubbing. The grease removal efficiency was calculated by dividing the L Spectral component delta f values of the positive control, Na-EDTA, by the L Spectral component of the cleaning composition and multiplying by 100. Water was used as a negative control.

A similar water dilutable grease cleaner formulation was used for each active component as shown in Table 1.

TABLE 1

| Cleaning Composition | Parts by Weight |
|---|---|
| Deionized water | 44.7 |
| Triethanolamine 99% LF | 5.0 |
| Sodium Hydroxide/Caustic Soda | 1.3 |
| Dodecyl Benzene Sulfonic Acid | 10.0 |
| 40% Sodium Xylene Sulfonate | 10.0 |
| 50% Sodium tolyltriazole (Wintrol CT) | 1.0 |
| Hostacor 2125 | 1.0 |
| Nexsurf 91-6 | 2.0 |
| Active component | 25.0 |

Hostacor 2125 is an iron corrosion inhibitor. Nexsurf 91-6 is an alcohol ethoxlate emulsifier. The active component was an aqueous composition comprising the chelator (or water for the negative control). The positive control was 40% Na₄EDTA (ethylene diamine tetra acetic acid, tetrasodium salt). The active component for Example 1 according to the invention was trans-1,2-diaminocyclohexane-N,N,N′,N′-tetra acetic acid (DCTA) and Example 2 according to the invention was nitrilo triacetic acid, disodium salt (DSIDA). The pH of Example 1 was adjusted to 11 and diluted to 40%. Example 2 required heating the DSIDA to liquefy it for introduction into the cleaning composition. The pH of Example 2 did not required adjusting (pH 11.97). The 99.5% active amount of DSIDA was diluted to 40%. To demonstrate the effectiveness of examples 1 and 2, these were compared with existing chelator agents, namely glutamic acid N,N-diacetic acid, tetrasodium salt (GLDA) and methyl glycine diacetic acid, trisodium salt (MGDA). Both of these comparative examples were also diluted to 40%.

The L spectral value is reported in Table 2 to demonstrate the grease removal efficiency.

TABLE 2

| | | L spectral | grease |
|---|---|---|---|
| | L spectral | value Delta | removal |
| | value prior | after | efficiency |
| Sample | to testing | cleaning | (%) |
| Negative Control (water) | 93.21 | 0.38 | 42.1 |
| Positive Control (Na₄EDTA) | 93.26 | 0.16 | 100 |
| Example 1 (DCTA) | 93.14 | 0.18 | 88.9 |
| Example 2 (DSIDA) | 93.32 | 0.17 | 94.1 |
| Comparative | 93.36 | 0.17 | 94.1 |
| Example A (GLDA) | | | |
| Comparative | 93.29 | 0.18 | 88.9 |
| Example B (MGDA) | | | |

Based on these results, Examples 1 and 2 demonstrate efficiency that comparable favorable with other known chelators in Comparative Example A and B based on the same weight %. Examples 1 and 2 are also an improvement over Comparative Example A and B because of DCTA and DSIDA have greater efficiency compared to the relevant equivalents based on EDTA. Equivalents is determined by number of moles of sodium divided by molecular weight of the chelator according to the formula according to the following formula: (22.989*Moles of Na)/MW of chelator.

Table 3 shows that Examples 1 and 2 have a low relative equivalents and thus a corresponding increase in degreasing efficiency at the same equivalents as EDTA (efficacy/rel. equivalence). This demonstrates that active compound of Examples 1 and 2 is suitable for use in cleaning composition by having superior degreasing efficiencies.

TABLE 3

| | | | | Degreasing |
|---|---|---|---|---|
| | | | | efficiency |
| | Moles | | | with same |
| Chelator | of Na | MW | Equivalents | equivalents, % |
| EDTA | 4 | 380.17 | 0.2419 | 100 |
| (positive control) | | | | |
| Example 1 (DCTA) | 4 | 452.28 | 0.2033 | 119 |
| Example 2 (DSIDA) | 2 | 221.07 | 0.2080 | 116 |
| Comparative | 4 | 351.13 | 0.2619 | 92 |
| Example A (GLDA) | | | | |
| Comparative | 3 | 271.11 | 0.2544 | 95 |
| Example B (MGDA) | | | | |

As used below, any reference to a series of embodiments is to be understood as a reference to each of those embodiments disjunctively. For example, “Embodiments 1-4” is to be understood as “Embodiments 1, 2, 3, or 4”.

Embodiment 1 is a cleaning composition comprising:
from 0.5 to 50 parts by weight of an aqueous solution containing an active component comprising (a) trans-1,2-diaminocyclohexane-N,N,N′,N′-tetraacetic acid monohydrate or salt thereof or (b) iminodiacetic acid or salt thereof;
from 0.01 to 25 parts by weight of a surfactant;
from 0.01 to 25 parts by weight of a corrosive inhibitor; and
remainder parts by weight of water,
wherein the parts by weight is based on 100 parts by weight of the composition.

Embodiment 2 is a cleaning composition of embodiment 1, wherein the active component comprises trans-1,2-diaminocyclohexane-N,N,N′,N′-tetraacetic acid.

Embodiment 3 is a cleaning composition of embodiment 1, wherein the active component comprises disodium iminodiacetate.

Embodiment 4 is a cleaning composition comprising:
from 0.5 to 50 parts by weight of an aqueous solution containing an active component comprising trans-1,2-diaminocyclohexane-N,N,N′,N′-tetraacetic acid monohydrate or salt thereof;
from 0.01 to 25 parts by weight of a surfactant;
from 0.01 to 25 parts by weight of a corrosive inhibitor; and
remainder parts by weight of water,
wherein the parts by weight is based on 100 parts by weight of the composition.

Embodiment 5 is a cleaning composition comprising:
from 0.5 to 50 parts by weight of an aqueous solution containing an active component comprising disodium iminodiacetate;
from 0.01 to 25 parts by weight of a surfactant;
from 0.01 to 25 parts by weight of a corrosive inhibitor; and
remainder parts by weight of water,
wherein the parts by weight is based on 100 parts by weight of the composition.

Embodiment 6 is a cleaning composition of any one of the embodiments 1-5, wherein the aqueous solution is present in an amount from 5 to 30 parts by weight.

Embodiment 7 is a cleaning composition of any one of the embodiments 1-6, wherein the aqueous solution contains from 30 to 70% of the active component.

Embodiment 8 is a cleaning composition of any one of the embodiments 1-7, wherein the pH of the aqueous solution is from 8 to 13.

Embodiment 9 is a cleaning composition of any one of the embodiments 1-8, wherein the cleaning composition comprises an alkanolamine comprising monoethanolamine, diethanolamine, triethanolamine, diethylethanolamine, triisopropanolamine, dimethylethanolamine, or combinations thereof.

Embodiment 10 is a cleaning composition of embodiment 9, wherein the cleaning composition comprises from 0.5 to 15 parts by weight of the alkanolamine

Embodiment 11 is a cleaning composition of any one of the embodiments 1-10, wherein the cleaning composition comprises an acidic component comprising a sulfuric acid, sulfonic acid, alkylsulfonic acid, nitric acid, acetic acid, formic acid, citric acid, phosphoric acid or combinations thereof.

Embodiment 12 is a cleaning composition of any one of the embodiments 1-11, wherein the surfactant comprises an alkyl benzene sulfonate.

Embodiment 13 is a cleaning composition of any one of the embodiments 1-12, wherein the corrosive inhibitor comprises triazoles, benzotriazoles, bisbenzotriazoles, aminotriazoles, alkylaminotriazoles, or the salts or complexes thereof.

Embodiment 14 is a cleaning composition of any one of the embodiments 1-13, wherein the surfactant comprises sodium dodecyl benzene sulfonate and the corrosive inhibitor comprises tolyltriazole.

Embodiment 15 is a cleaning composition of any one of the embodiments 1-14, further comprising less than 0.5 parts by weight of phosphorous-containing compounds and/or chlorine-containing compounds.

Embodiment 16 is a cleaning composition of any one of the embodiments 1-15, further comprising one or more additives including bleaches, enzymes, solvents, salts, soil release polymers, foam inhibitors, fragrances, fillers, biocides, inorganic extenders, formulation auxiliaries, solubility improvers, dyes, peroxide stabilizers, electrolytes, soaps, detergents, oxidizing agents, antimicrobial agents, or combinations thereof.

1. A cleaning composition comprising:
from 0.5 to 50 parts by weight of an aqueous solution containing an active component comprising (a) trans-1,2-diaminocyclohexane-N,N,N′,N′-tetraacetic acid monohydrate or salt thereof or (b) iminodiacetic acid or salt thereof;
from 0.01 to 25 parts by weight of a surfactant;
from 0.01 to 25 parts by weight of a corrosive inhibitor; and
remainder parts by weight of water,
wherein the parts by weight is based on 100 parts by weight of the composition.

2. The cleaning composition of claim 1, wherein the aqueous solution is present in an amount from 5 to 30 parts by weight.

3. The cleaning composition of claim 1, wherein the aqueous solution contains from 30 to 70% of the active component.

4. The cleaning composition of claim 1, wherein the active component comprises trans-1,2-diaminocyclohexane-N,N,N′,N′-tetraacetic acid.

5. The cleaning composition of claim 1, wherein the active component comprises disodium iminodiacetate.

6. The cleaning composition of claim 1, wherein the pH of the aqueous solution is from 8 to 13.

7. The cleaning composition of claim 1, wherein the cleaning composition comprises an alkanolamine comprising monoethanolamine, diethanolamine, triethanolamine, diethylethanolamine, triisopropanolamine, dim ethylethanolamine, or combinations thereof.

8. The cleaning composition of claim 7, wherein the cleaning composition comprises from 0.5 to 15 parts by weight of the alkanolamine.

9. The cleaning composition of claim 1, wherein the cleaning composition comprises an acidic component comprising a sulfuric acid, sulfonic acid, alkylsulfonic acid, nitric acid, acetic acid, formic acid, citric acid, phosphoric acid or combinations thereof.

10. The cleaning composition of claim 1, wherein the surfactant comprises an alkyl benzene sulfonate.

11. The cleaning composition of claim 1, wherein the corrosive inhibitor comprises triazoles, benzotriazoles, bisbenzotriazoles, am inotriazoles, alkylaminotriazoles, or the salts or complexes thereof.

12. The cleaning composition of claim 1, further comprising less than 0.5 parts by weight of phosphorous-containing compounds and/or chlorine-containing compounds.

13. The cleaning composition of claim 1, further comprising one or more additives including bleaches, enzymes, solvents, salts, soil release polymers, foam inhibitors, fragrances, fillers, biocides, inorganic extenders, formulation auxiliaries, solubility improvers, dyes, peroxide stabilizers, electrolytes, soaps, detergents, oxidizing agents, antimicrobial agents, or combinations thereof.

14. A cleaning composition comprising:
from 0.5 to 50 parts by weight of an aqueous solution containing an active component comprising trans-1,2-diaminocyclohexane-N,N,N′,N′-tetraacetic acid monohydrate or salt thereof;
from 0.01 to 25 parts by weight of a surfactant;
from 0.01 to 25 parts by weight of a corrosive inhibitor; and
remainder parts by weight of water,
wherein the parts by weight is based on 100 parts by weight of the composition.

15. The cleaning composition of claim 14, wherein the corrosive inhibitor comprises triazoles, benzotriazoles, bisbenzotriazoles, aminotriazoles, alkylaminotriazoles, or the salts or complexes thereof.

16. The cleaning composition of claim 14, wherein the cleaning composition comprises an alkanolamine comprising monoethanolamine, diethanolamine, triethanolamine, diethylethanolamine, triisopropanolamine, dimethylethanolamine, or combinations thereof.

17. The cleaning composition of claim 14, wherein the active component comprises trans-1,2-diaminocyclohexane-N,N,N′,N′-tetraacetic acid.

18. A cleaning composition comprising:
from 0.5 to 50 parts by weight of an aqueous solution containing an active component comprising iminodiacetic acid or salt thereof;
from 0.01 to 25 parts by weight of a surfactant;
from 0.01 to 25 parts by weight of a corrosive inhibitor; and
remainder parts by weight of water,
wherein the parts by weight is based on 100 parts by weight of the composition.

19. The cleaning composition of claim 18, wherein the corrosive inhibitor comprises triazoles, benzotriazoles, bisbenzotriazoles, aminotriazoles, alkylaminotriazoles, or the salts or complexes thereof.

20. The cleaning composition of claim 18, wherein the cleaning composition comprises an alkanolamine comprising monoethanolamine, diethanolamine, triethanolamine, diethylethanolamine, triisopropanolamine, dimethylethanolamine, or combinations thereof.
